(19) United States
(12) Patent Application Publication
(10) Pub. No.: US 2015/0116699 A1
(43) Pub. Date: Apr. 30, 2015

(54) REMOVABLE DEVICE FOR INSPECTING POLISH OF AN OPTICAL FIBER ENDFACE USING A PORTABLE CAMERA, AND RELATED COMPONENTS, SYSTEMS, AND METHODS

(71) Applicant: Corning Cable Systems LLC, Hickory, NC (US)

(72) Inventors: David Wayne Meek, Ft. Worth, TX (US); Qi Wu, Painted Post, NY (US)

(73) Assignee: Corning Cable Systems LLC, Hickory, NC (US)

(21) Appl. No.: 14/068,349

(22) Filed: Oct. 31, 2013

(51) Int. Cl. G01M 11/00

(52) U.S. Cl. CPC G01M 11/31
USPC 356/73.1

(57) ABSTRACT

A fiber inspection device is configured to be removably attached to a portable camera, such as a smartphone or other mobile computing device. The device may be arranged to have a slim form factor that complements the form factor of the smartphone or other device. The device may be configured to inspect a polish and/or cleave of the optical fiber. By leveraging the built in camera, computing power and user interface of a smartphone or other mobile computing device, a fiber inspection device can be inexpensively produced for inspecting a polish of an optical fiber endface using mass market camera hardware and software, without the need to develop dedicated electronics hardware or embedded software.

### BACKGROUND

The disclosure relates generally to fiber optics and more particularly to a removable device for a portable camera, which may be used to inspect a polish of an optical fiber endface.

Optical fibers can be used to transmit or process light in a variety of applications. Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support interconnections.

Optical communication networks involve termination preparations to establish connections between disparate optical fibers. For example, optical fibers can be spliced together to establish an optical connection. Optical fibers can also be connectorized with fiber optic connectors that can be plugged together to establish an optical connection. In either case, it may be necessary for a technician to establish the optical connection in the field. The technician cleaves the optical fiber to prepare an end face on the optical fiber. The technician may employ a cleaver that includes a blade to score, scribe, or otherwise induce a flaw in the glass of the optical fiber. Inducing a flaw in the glass of an optical fiber precedes breaking the glass at the flaw to produce an end face. The blade may either be pressed into the glass or swiped across the glass to induce the flaw. The end face can then either be spliced to another optical fiber or connectorized with a fiber optic connector to establish an optical connection.

Optical fiber polish and cleave quality plays a crucial part in fiber connection loss. For example, the mode field diameter can be as small as 10 μm for single mode fibers. Scratches, dust particles, cracks, or irregularities in the fiber surface can strongly attenuate optical coupling and reduce long term reliability. As such, end face inspection of optical connectors and cleaved fibers by microscopy has been an important quality control method in fiber optics industry. Such equipment is widely used in manufacturing settings, laboratories, and increasingly in the field, with field-installable connectors typically requiring polishing or mechanical cleave in the field. End face inspection can improve the yield by verifying the quality of polish and cleave.

No admission is made that any reference cited herein constitutes prior art. Applicant expressly reserves the right to challenge the accuracy and pertinency of any cited documents.

### SUMMARY

Embodiments include a fiber inspection device configured to be removably attached to a portable camera, such as a smartphone or other mobile computing device as non-limiting examples. The fiber inspection device may be arranged to have a slim form factor that complements the form factor of the smartphone or other device. The fiber inspection device may be configured to inspect a polish and/or cleaved endface of an optical fiber. By leveraging the built in camera of the mobile computing device, along with the computing power and user interface of the mobile computing device, a fiber inspection device can be inexpensively produced for inspecting a polish and/or cleave of an optical fiber endface using mass market camera hardware and software, without the need to develop dedicated electronics hardware or embedded software.

One embodiment of the disclosure relates to a fiber inspection device configured to be removably attached to a portable camera for inspecting an optical fiber. The fiber inspection device comprises an optical fiber guide configured to guide and maintain an end portion of a first optical fiber via the first end of the optical fiber guide such that an endface of the first optical fiber extends to the second end of the optical fiber guide. The fiber inspection device further comprises a beam splitter comprising an inspection optical interface configured to receive and direct light returned from the endface of the first optical fiber in a first optical path. The beam splitter further comprises at least one optical splitter disposed in the first optical path configured to direct returned light returned from the microhole via the first inspection optical interface to an inspection optical output in a second optical path perpendicular to the first optical path, to be imaged by the portable camera.

In another exemplary embodiment, a method of inspecting optical fiber is disclosed. The method comprises providing a portable camera having an optical input and a fiber inspection device removably attached to the portable camera. The method further comprises inserting an end portion of the first optical fiber into a microhole of an adaptor ferrule of the fiber inspection device having a first end and a second end such that an endface of the first optical fiber extends to the second end of the adaptor ferrule. The method further comprises receiving light returned from the microhole in an input optical path at the optical input of the camera via a first inspection optical interface of a beam splitter in an input optical path configured to direct returned light returned from the microhole via the first inspection optical interface to an inspection optical output in an output optical path perpendicular or substantially perpendicular to the input optical path, to be imaged by the portable camera.

In another exemplary embodiment, an optical fiber inspection system is disclosed. The system comprises a portable camera having an optical input and a camera body, and a fiber inspection device removably attached to the portable camera for inspecting an optical fiber. The fiber inspection device comprises an adaptor ferrule comprising a microhole disposed between a first end and a second end of the adaptor ferrule. The adaptor ferrule is configured to receive an end portion of a first optical fiber via the first end of the adaptor ferrule such that an endface of the first optical fiber extends to the second end of the adaptor ferrule. The fiber inspection device further comprises a beam splitter, comprising an inspection optical interface configured to receive and direct light returned from the endface of the first optical fiber in a first optical path. The beam splitter further comprises at least one optical splitter disposed in the first optical path configured to direct returned light returned from the microhole via a first inspection optical interface to the optical input of the camera via an inspection optical output in a second optical path perpendicular to the first optical path, to be imaged by the portable camera.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments. Persons skilled in the art will appreciate how features and attributes associated with embodiments shown in one of the drawings may be applied to embodiments shown in others of the drawings.

### BRIEF DESCRIPTION OF THE DRAWINGS

FIG. 1A is a perspective view of a conventional handheld microscope for inspecting a polish of an optical fiber endface according to the prior art;

FIG. 1B is another view of the microscope of FIG. 1A being used to inspect a polish of an optical fiber endface;

FIGS. 2A and 2B are respective back and side views of a smartphone having a removably attachable fiber inspection device for inspecting a polish and/or a cleave of an optical fiber endface according to an exemplary embodiment;

FIG. 3 is a schematic diagram of a fiber inspection device similar to the fiber inspection device of FIGS. 2A and 2B for inspecting a polish of an optical fiber endface according to another exemplary embodiment;

FIG. 4 is a schematic diagram of a fiber inspection device similar to the fiber inspection device of FIGS. 2A and 2B for inspecting a cleave of an optical fiber endface according to another exemplary embodiment;

FIG. 5 is a schematic diagram of a fiber inspection device similar to the fiber inspection device of FIGS. 2A and 2B for inspecting a polish and a cleave of an optical fiber endface according to another exemplary embodiment;

FIG. 6 is a schematic diagram of a fiber inspection device similar to the fiber inspection device of FIG. 5 for inspecting a polish and a cleave of an endface of an optical fiber disposed in a fiber optic connector according to another exemplary embodiment;

FIGS. 7A and 7B are respective back and side views of a fiber inspection device having an integrated camera and display for inspecting a polish and/or a cleave of an optical fiber endface according to another exemplary embodiment;

FIG. 8 is an exemplary camera image captured at the focal plane of a fiber inspection device according to an exemplary embodiment, illustrating a polish of an optical fiber endface;

FIG. 9 is an exemplary image of an interference pattern of interference generated by an interferometer captured at the focal plane of a fiber inspection device from the end face of the cleaved optical fiber in FIG. 4A to illustrate an exemplary quality of the surface of the end face;

FIG. 10 is a flowchart diagram of an exemplary method for inspecting a polish of an optical fiber endface using a portable camera and a removably attachable fiber inspection device according to an exemplary embodiment;

FIG. 11 is a flowchart diagram of an exemplary method for inspecting a cleave of an optical fiber endface using fiber inspection device according to an exemplary embodiment.

### DETAILED DESCRIPTION

Embodiments include a fiber inspection device configured to be removably attached to a portable camera, such as a smartphone or other mobile computing device as non-limiting examples. The fiber inspection device may be arranged to have a slim form factor that complements the form factor of the smartphone or other device. The fiber inspection device may be configured to inspect a polish and/or cleaved endface of an optical fiber. By leveraging the built in camera of the mobile computing device, along with the computing power and user interface of the mobile computing device, a fiber inspection device can be inexpensively produced for inspecting a polish and/or cleave of an optical fiber endface using mass market camera hardware and software, without the need to develop dedicated electronics hardware or embedded software.

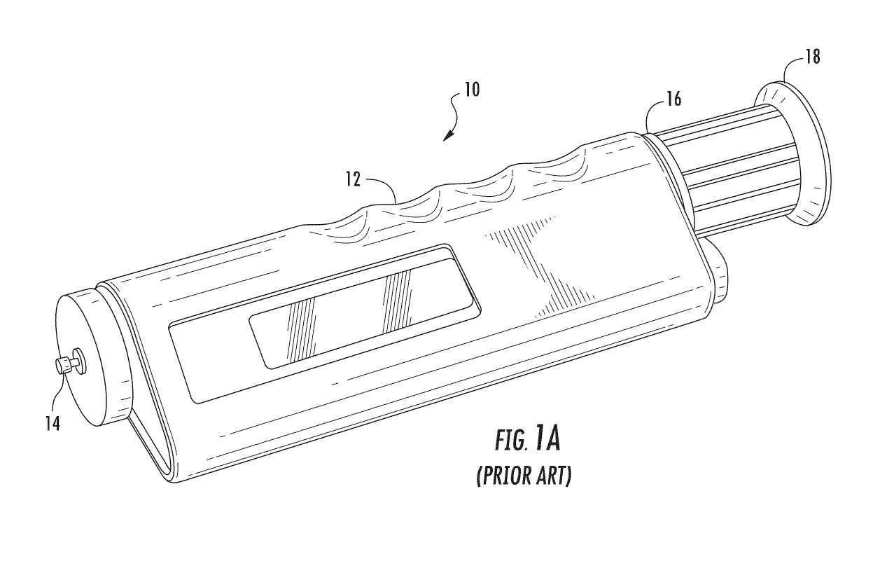

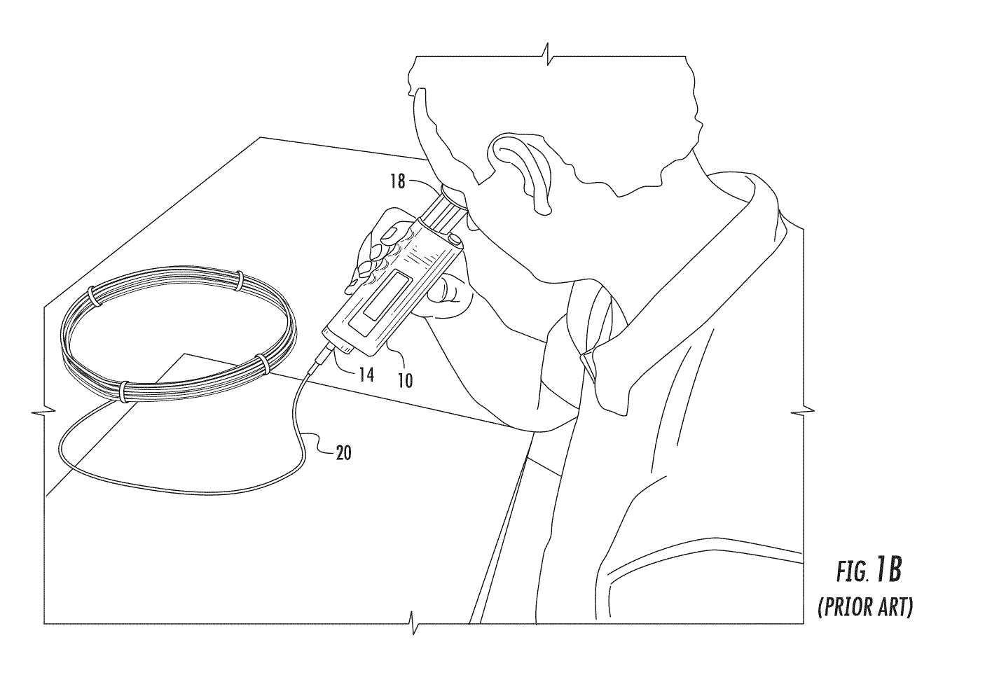

Various embodiments will be further clarified by the following examples. Before discussing the embodiments in detail, reference will now be made to examples of conventional fiber inspection tools and methods. In this regard, FIG. 1A is a perspective view of a conventional handheld microscope 10 for inspecting a polish of an optical fiber endface according to the prior art. The microscope 10 includes a housing 12 with an integrated grip surface 12 having an optical input 14 on a distal end. The microscope 10 also includes an objective 16 at an opposite end connected to an eyepiece 18 for manually inspecting the polish of an endface of optical fiber 20, as shown in FIG. 1B. However, a dedicated microscope such as microscope 10 is relatively bulky, requires manual focusing, and may also include a risk to the user's eyesight if its built-in safety mechanisms fail and direct a laser from the fiber optic endface into a user's eye.

Other devices designed, for example for medical diagnostics, contain components sufficient to perform optical microscopy and fluorescence microscopy, but existing devices are also bulky, and are expensive due to the highly specialized nature of the devices. Accordingly, there is a need for a compact, ergonomic, and easy to use fiber inspection device that leverages the existence of existing portable camera technology, and that has capabilities for advanced functions such as interferometric and other measurements. Such a device may include an integrated camera, or may be configured to be removably attached to an existing portable camera, such as a smartphone or other relatively low cost camera device. For example, because smartphones are manufactured in high volumes, the cost of the camera components may be of sufficient quality for microscopy at a significantly reduced price over customized solutions. Thus, by leveraging the existing camera lens focus and sensor technology to permit inspection of an endface of an optical fiber, field inspection of bare optical fiber becomes easier and more economical.

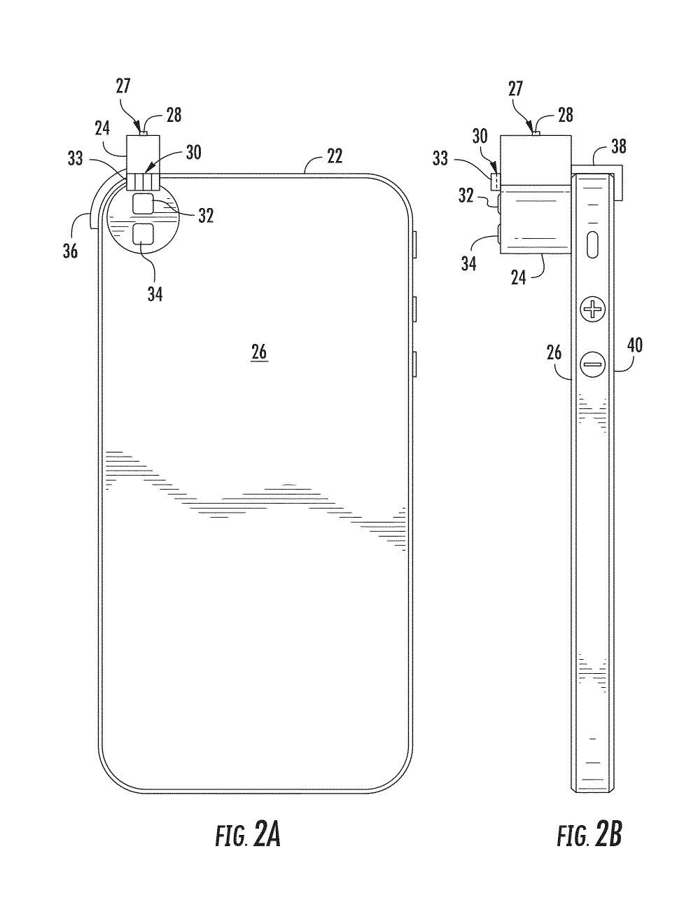

In this regard, FIGS. 2A and 2B are respective back and side views of a smartphone 22 having a removably attachable fiber inspection device 24 for inspecting a polish and/or a cleave of an optical fiber endface, according to an exemplary embodiment. In this embodiment, the fiber inspection device 24 is configured to be removably attached to the back surface 26 of the smartphone 22. The fiber inspection device 24 in this embodiment includes an optical fiber guide 27 for guiding and retaining an end of the optical fiber 20, so that the endface can be imaged by the camera of the smartphone 22. In this embodiment, the optical fiber guide 27 is an adapter ferrule 28. The fiber inspection device 24 of this embodiment also includes another optical fiber guide 30 configured to guide and retain an end of the optical fiber at a focal distance from another optical input 32. In this embodiment, optical fiber guide 30 is a V-groove 33 configured to loosely guide and align an optical fiber with respect to the optical input 32. This permits the fiber inspection device 24 to enable inspection of a cleave of the optical fiber endface in addition to the polish of the optical fiber endface. One advantage of this arrangement is that the fiber clip can be rotated in place, and, because of the auto focusing capability of cameras in many mobile devices, such as smartphone 22, the fiber movements during rotation does not require manual focusing. Another advantage of this arrangement is that, while it is important to attain a smooth uniform polish of the optical fiber endface, it can be equally important that the initial cleave generate a flat and uniform surface. In particular, some fiber optic connectors only include a cleaving step during assembly, and do not include a polishing step. If an adequate cleave is not attained, signal attenuation may occur. While some fiber optic connectors do not include a cleaving step during assembly, others include both a cleaving and a polishing step during assembly. Thus, by enabling both cleave and polish inspection in the field, versatility of the fiber inspection device 24 can be increased, and overall quality control can also be increased.

The fiber inspection device 24 of FIGS. 2A and 2B also includes an ambient light input 34 configured to direct ambient light into the fiber inspection device 24 and illuminate the end of the optical fiber, when the optical fiber is disposed in one of the adaptor ferrule 28 or the optical fiber guide 30, thereby allowing the camera of smartphone 22 to obtain a high quality image of the optical fiber.

In this embodiment, the fiber inspection device 24 is removably attached to the back surface 26 of smartphone 22. As shown in FIGS. 2A and 2B, alignment clips 36, 38 are attached to fiber inspection device 24 and are shaped to conform to the specific shape of the smartphone 22. However, it should be noted that any number of alignment and/or attachment mechanisms may be included in addition or as alternatives, for example, adhesives, or suction or clamping mechanisms. Moreover, the fiber inspection device 24 may be incorporated into a case or cover for the smartphone 22, with such case or cover including the alignment and/or attachment mechanisms. With the fiber inspection device 24 attached to and/or aligned with the camera of the smartphone 22, a user can simply interface with the camera of the smartphone 22 via the touchscreen 40 of the smartphone 22 or other input or interface mechanisms. Because many common smartphones 22 also include autofocus capability, the size and number of components within the removable fiber inspection device 24 itself can be minimized, thereby enabling the fiber inspection device 24 to have a small, slim form factor.

One advantage of this and other embodiments is that the fiber inspection device 24 can be made compact and ergonomic. Because the fiber inspection device 24 employs micro optics and does not require electronic components, the size and weight of the fiber inspection device 24 can be significantly reduced. In addition, an existing smartphone design and interface can be used, making the fiber inspection device 24 ergonomic and easy to use in both a lab and field settings.

Another advantage of the fiber inspection device 24 is the relatively low cost compared to a fully integrated solution. The fiber inspection device 24 leverages the built in camera, computing power and user interface of smartphone 22 or other mobile computing device. Because the inexpensive, mass produced imaging hardware and software already exists as part of these mobile computing devices, a simple add-on solution such as fiber inspection device 24 can be produced without the need to develop dedicated electronics hardware or embedded software.

As will be discussed below as well, the fiber inspection device 24 also allows for unique functionalities, such as interferometric imaging capability. By integrating interferometric imaging into the low-cost fiber inspection device 24, connector end face geometry measurement can be achieved in a very low cost platform.

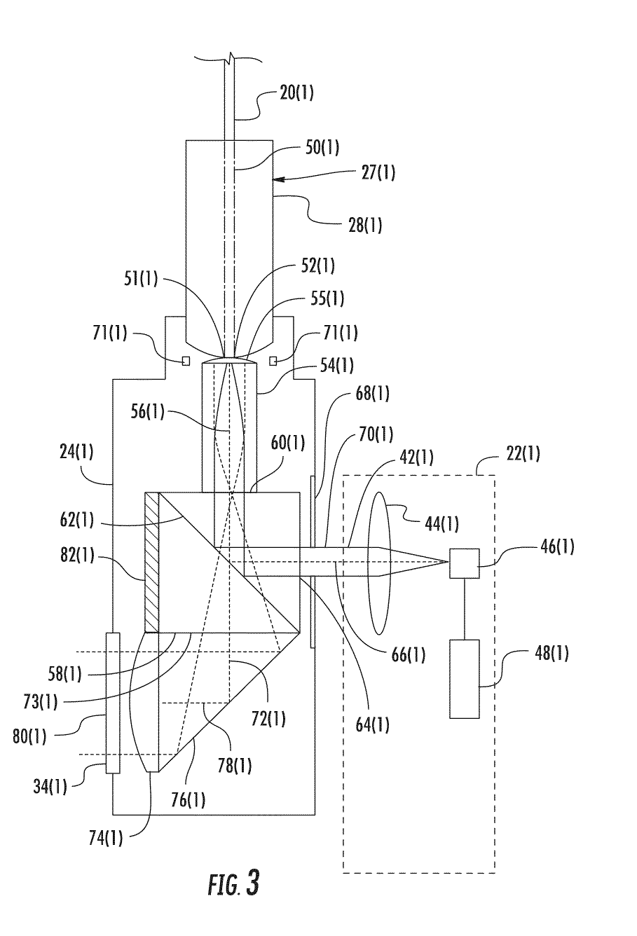

In this regard, FIG. 3 is a schematic diagram of a fiber inspection device similar to the fiber inspection device of FIGS. 2A and 2B for inspecting a polish of an optical fiber endface, according to another exemplary embodiment. In this example, fiber inspection device 24(1) is configured to only inspect a polish of an optical fiber endface 51(1). In addition, the fiber inspection device 24(1) is oriented such that the adapter ferrule 28(1) is oriented perpendicular to a camera input 42(1) of smartphone 22(1).

The camera functionality of smartphone 22(1) includes a lens 44(1) and an image sensor 46(1), which is operably connected to processing components 48(1), which may include, for example, a processor, memory, storage, and other computing components. The adapter ferrule 28(1) includes a microhole 50(1) configured to receive an end of optical fiber 20(1) such that endface 51(1) of optical fiber 20(1) is positioned against a first optical input 52(1) of the fiber inspection device 24(1). In this example, to maintain a small form factor, a GRIN lens 54(1) (or other micro-objective) is disposed at the first optical input 52(1) such that light is channeled and directed along a first optical axis 56(1) between the first optical input 52(1) and a beam splitter 58(1), which is connected to the GRIN lens 54(1) at a first optical interface 60(1). In this embodiment, the first optical input 52(1) can include a convex surface such as a lens 55(1). Lens 55(1) can be integrated into the GRIN lens 54(1) or can be a separate component.

The end face 51(1) of optical fiber 20(1) is brought to close proximity or direct contact with the first optical input 52(1) of GRIN lens 54(1). The surface of the first optical input 52(1) is scratch resistant when contact measurement is required. The focal length of the GRIN lens 54(1) is similar to or smaller than that of the camera lens 44(1) in order to achieve high spatial resolution. Light returned from the endface 51(1) of optical fiber 20(1) is directed along the first optical axis 56(1) into beam splitter 58(1) and is reflected by optical splitter 62(1) to a second optical interface 64(1) along a second optical axis 66(1) toward camera input 42(1). An aperture stop 68(1) is disposed over the camera input 42(1), for example to prevent light directed into the camera input 42(1) via aperture 70(1), and to also prevent ambient light from interfering with the light returned from endface 51(1). The aperture stop 68(1) is also used to control the numerical aperture of the imaging system.

In this example, the endface 51(1) of optical fiber 20(1) can be illuminated by integrated light sources 71(1). Light sources 71(1) may be light emitting diodes (LEDs) or other suitable light producing element. Alternatively, this embodiment is also configured to illuminate the endface 51(1) using ambient light which is directed into the beam splitter 58(1) along a third optical axis 72(1) via a third optical interface 73(1). In this example, ambient light is received through lens 74(1), which directs the ambient light to a beam bender 76(1) along a fourth optical axis 78(1). The beam bender 76(1) reflects the ambient light along the third optical axis 72(1), which is coaxial with second optical axis 56(1). The ambient light is reflected off of the endface 51(1) of optical fiber 20(1) back towards beam splitter 58(1). In this example, the first and fourth optical axes 66(1), 78(1) are parallel to each other and are perpendicular to second and third optical axes 56(1), 72(1). This permits a slim form factor, for example, by allowing the adaptor ferrule 28(1) to be disposed parallel to the length of the smartphone 22(1). This arrangement also allows ambient light to enter lens 74(1) at a surface directed away from the smartphone 22(1), thereby permitting a maximum amount of ambient light to enter the lens 74(1). In an alternative embodiment, the beam bender 76(1) and lens 74(1) could be oriented toward the smartphone 22(1), for example to align with a flash LED or other LED (not shown) of the smartphone 22(1).

In this example, an optional band pass filter 80(1) may also be disposed in front of lens 74(1) in order to normalize and regulate the amount and wavelengths of ambient light entering the lens 74(1). For example, because a GRIN lens as micro objective is not necessarily achromatic, a band pass filter 80(1) may be desirable to maintain a bandwidth of illumination light source in a preferred range narrower than 20 nm. As noted above, the ambient light source can be a single color LED, ambient light or white light LED, and may be integrated into the fiber inspection device 24(1) or smartphone 22(1).

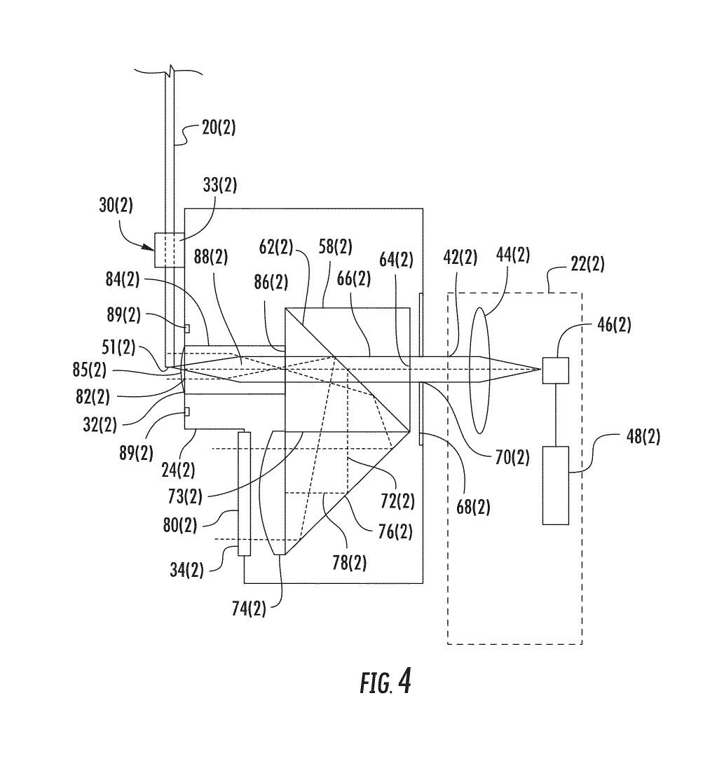

In addition to inspecting an endface 51 of an optical fiber 20 directly, for example to inspect a polish of the endface 51, it may also be desirable to inspect a cleave of the endface 51 of the optical fiber. In this regard, FIG. 4 illustrates a schematic diagram of a fiber inspection device for inspecting a cleave of an optical fiber endface according to another example embodiment. In this example, a smartphone 22(2) having similar internal components has a fiber inspection device 24(2) removably attached thereto. In this example, light is returned from endface 51(2) of optical fiber 20(2) via a second optical interface 82(2) of fiber inspection device 24(2). A GRIN lens 84(2), which may include an integrated or attached convex lens 85(2) similar to the lens 55(1) of FIG. 3, directs the returned light to a fourth optical interface 86(2) of beam splitter 58(2) via a fifth optical axis 88(2).

As with the embodiment described in FIG. 3 above, light producing elements 89(2) may be included to illuminate the optical fiber endface 51(2), and ambient light may also be optionally directed towards the endface 51(2) of optical fiber 22 via optional ambient light input 34(2). Ambient light in this example is reflected by beam bender 76(2) from the fourth optical axis 78(2) to the third optical axis 72(2), and is in turn reflected by the optical splitter 62(2) toward the endface 51(2) of the optical fiber 20(2) along the fifth optical axis 88(2). In this manner, a fiber inspection device, such as fiber inspection device 24(2), can easily and economically image a cleave of an optical fiber 20, thereby increasing the reliability of optical fibers cut and installed in the field.

In another example, the polish inspection and cleave inspection functions may be integrated into a single fiber inspection device. In this regard, FIG. 5 illustrates fiber inspection device 24(3), which includes both an adaptor ferrule 28(3) disposed at a first optical input 52(3) for inspecting a polish of endface 51(1) of optical fiber 20(1), and also optical input 32(3) for inspecting a cleave of endface 51(2) of optical fiber 20(2). It should be noted that, although optical fibers 20(1), 20(2) are illustrated as separate optical fibers, one intended use of the dual input fiber inspection device 24(3) of FIG. 5 would be to inspect the cleave and polish of a single endface of an optical fiber in sequence, to verify that both the polish and the cleave of the endface 51 are of sufficient quality.

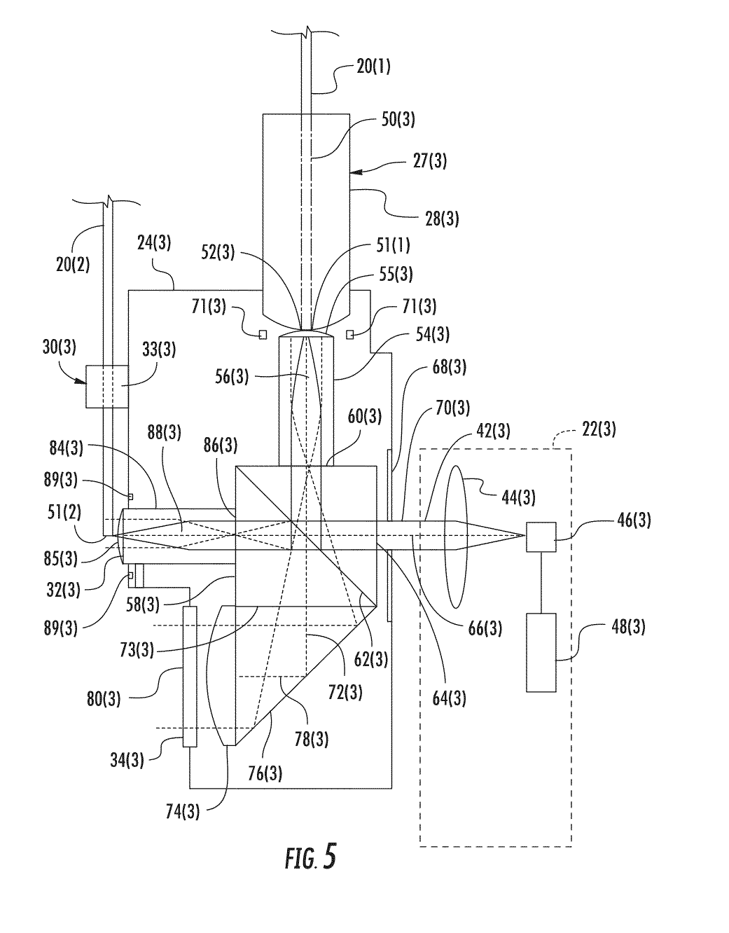

In the above examples, the inspection devices 24 are configured to inspect the endfaces 51 of bare optical fibers 20. In other embodiments, however, it may be desirable to inspect an endface of an optical fiber disposed in a pre-assembled fiber optic connector. In this regard, FIG. 6 illustrates fiber inspection device 24(4), which includes similar internal components to fiber inspection device 24(3) of FIG. 5, discussed above. In this example, however, the optical fiber guide 27(4) is a fiber optic adaptor sleeve 89 for receiving and retaining a pre-assembled fiber optic connector 90. In this and other embodiments, any other suitable mechanical guide may be substituted for fiber optic adaptor sleeve 89. In addition, the optical fiber guide 30 in this embodiment is also a fiber optic adaptor sleeve 91, thereby permitting inspection of the cleave of an endface of an optical fiber disposed in the pre-assembled fiber optic connector 90 as well.

In one example, the smartphone 22 may be a consumer phone, such as an Apple® iPhone 4S™. The back camera of an exemplary Apple® iPhone 4S™ has an effective focal length of 4.28 mm and an F number of 2.4. The image sensor 46 has 3264×2448 pixels, and the size of each pixel is 1.4 μm. A quarter pitch GRIN lens 54, 84 (Edmund Optics, NT 64-519) with effective focal length of 1.69 mm at 670 nm and an outer diameter of 1.8 mm is suitable for use in this embodiment. The beam splitter 58 may be a 5 mm³ cube beam splitter. Thus, the size of the fiber inspection device 24 is significantly smaller than conventional inspection devices.

It should be understood, however, that mobile devices described herein may be smartphones, tablets, iPods®, phablets, laptops, or other mobile computing devices having integrated cameras. The same fiber inspection device 24 can be used for different devices by using modular attachment components, which connect the smartphone 22 and the fiber inspection device 24.

The inspection devices described herein may operate with the built in software applications (apps) of the smartphone 22 for zooming, autofocusing and saving of the fiber end face images. Apps may also be developed to provide custom functions such as contrast enhancement, dust recognition, and geometry measurements. The smartphone 22 can be used to store, transfer, manage, and analyze the images taken by the camera. For example, the hardware and/or software of smartphone 22 may be configured to capture images of the optical fiber 20 and endface 51. The smartphone 22 may also be configured to display live and captured still and/or moving images of the optical fiber 20 and endface 51, such as via a built in display, or shared via a network connection. The captured images can be stored, transferred, and managed by the smartphone 22 hardware and/or software. In addition, the software of smartphone 22 may be further configured to analyze the captured images, and may also be configured to annotate or otherwise process the captured images in order to provide useful information. The above functions may be configured to be performed manually, automatically, or both.

If the fiber cable is printed with bar codes, it can also be scanned by the mobile device to QC the cable, while providing a way of tracing the cable without additional equipment cost.

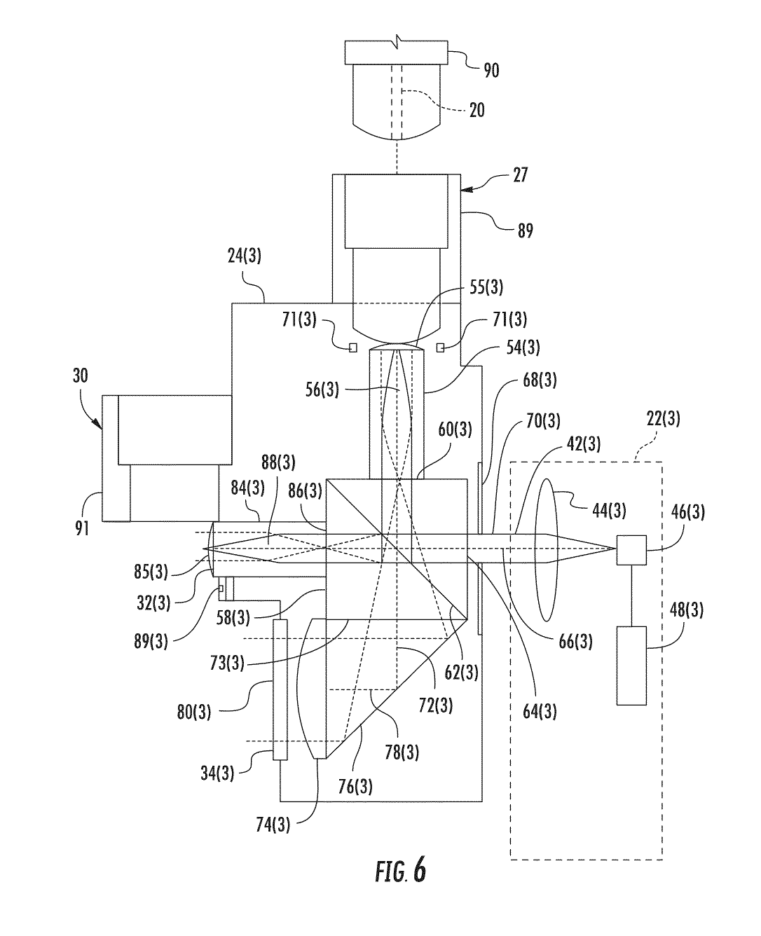

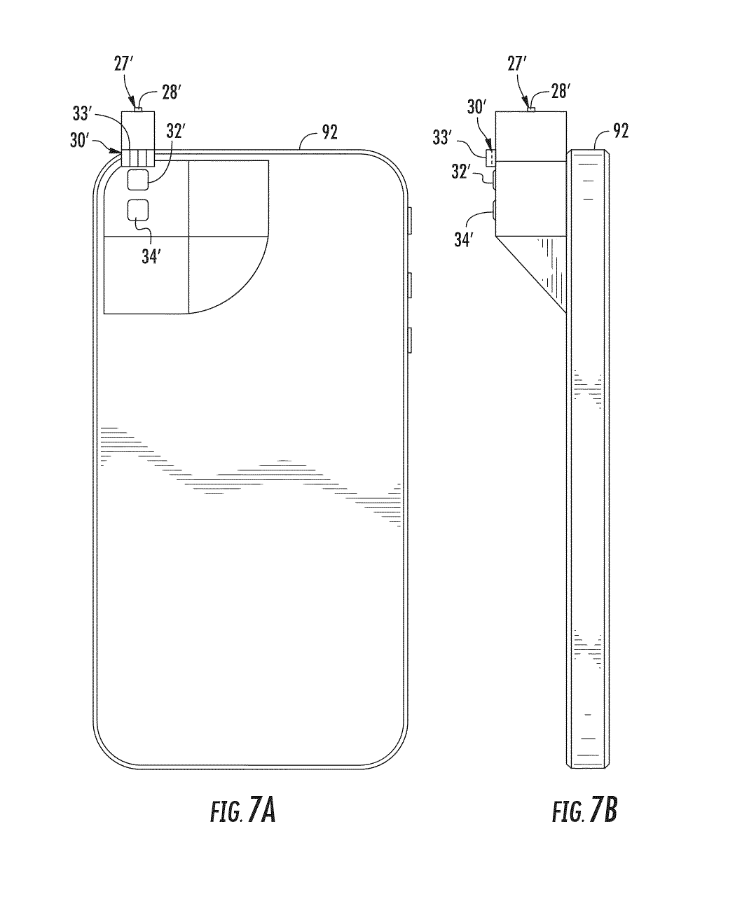

In the above examples of FIGS. 2A through 6, fiber inspection device 24 is removably attachable to a smartphone 22 or other portable camera or personal electronic device. In other embodiments, it may be desirable to assemble a fiber inspection device as a single unit having an integrated camera. In this regard, FIGS. 7A and 7B illustrate respective back and side views of a fiber inspection device 90 having an integrated camera function similar to the camera function of smartphone 22 described above with respect to FIGS. 2A through 5. Similar to a fiber inspection device 24 of FIGS. 2A and 2B, fiber inspection device 92 of FIGS. 7A and 7B includes adapter ferrule 28′, optical fiber guide 30′, optical input 32′, and ambient light input 34′, which have similar components and functionality to the components of FIGS. 2A through 5.

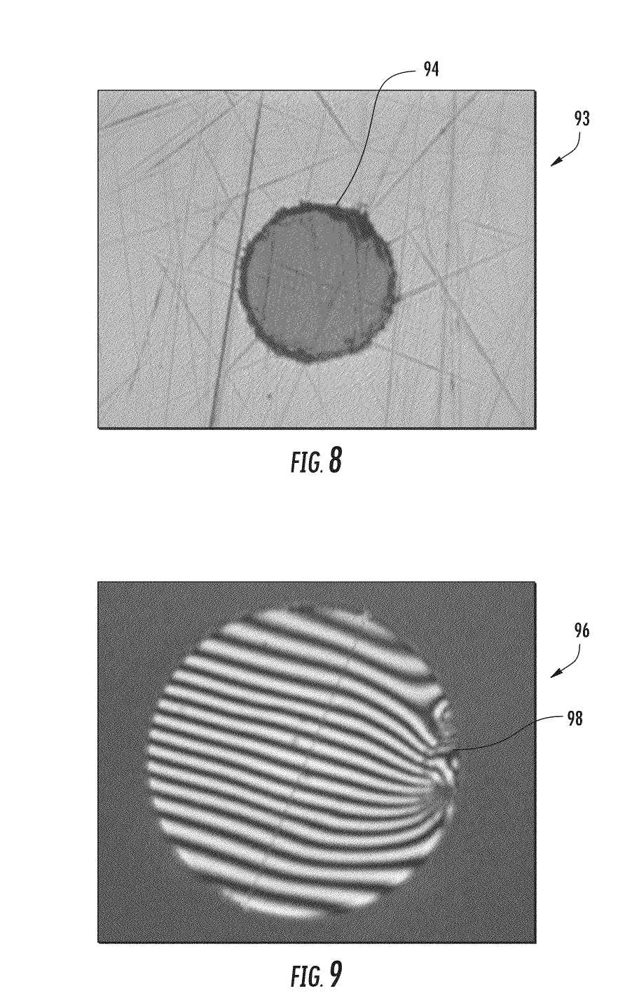

FIG. 8 is an exemplary camera image 93 captured at the focal plane of a fiber inspection device according to an exemplary embodiment, illustrating a polish of an optical fiber endface 94. In many applications, such as field installation, a simple visual inspection of the polish and cleave is sufficient to determine whether a cut fiber has sufficient endface quality. In addition, the above embodiments also allow for more exact measurement of endface quality. In this regard, FIG. 9 is an exemplary image 96 of a pattern of interference generated by an interferometer captured at the focal plane of a fiber inspection device from the end face 94 of the cleaved optical fiber in FIG. 8 to illustrate an exemplary quality of the surface of the end face 94. Thus, the above embodiments can allow for very precise inspection of an optical fiber endface, whether in the lab or in the field.

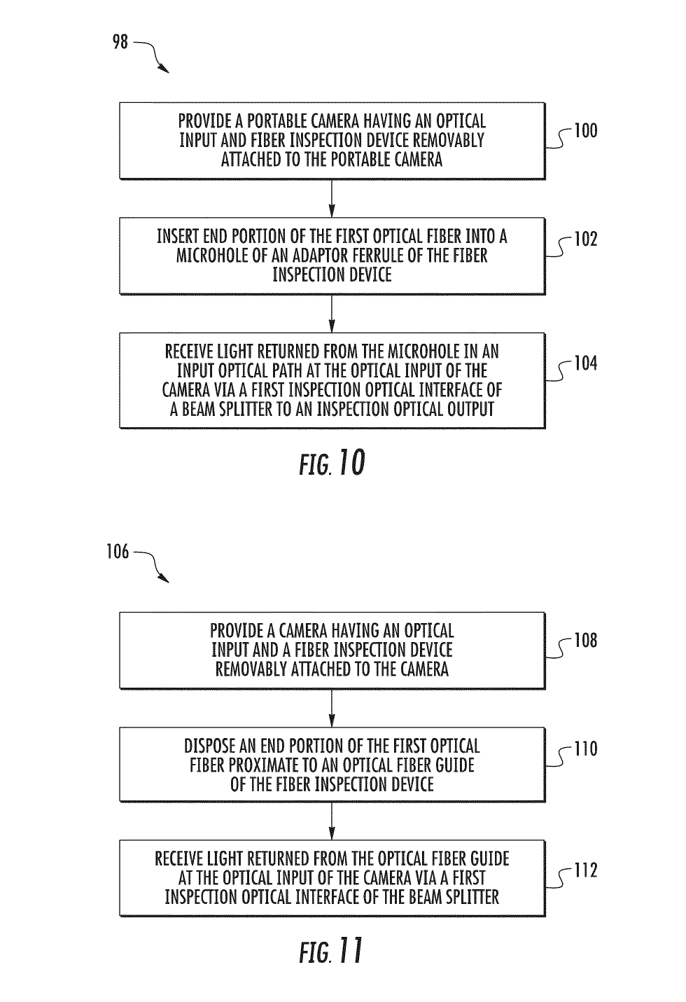

FIG. 10 is a flowchart diagram of an exemplary method 98 for inspecting a polish of an optical fiber endface, such as endface 51 of optical fiber 20, using a portable camera, such as smartphone 22, and a removably attachable fiber inspection device, such as fiber inspection device 24, according to an exemplary embodiment. The method includes providing a portable camera having an optical input and a fiber inspection device removably attached to the portable camera (block 100). Next, an end portion of the first optical fiber is inserted into a microhole of an adaptor ferrule of the fiber inspection device having a first end and a second end such that the endface of the first optical fiber extends to the second end of the adaptor ferrule (block 102). The method also includes receiving light returned from the microhole in an input optical path at the optical input of the camera via a first inspection optical interface of a beam splitter to an inspection optical output in an output optical path perpendicular or substantially perpendicular to the input optical path, to be imaged by the portable camera (block 104).

In another example, FIG. 11 is a flowchart diagram of exemplary method 106 for inspecting a cleave of an optical fiber endface, such as endface 51 of optical fiber 20, using fiber inspection device, such as fiber optic inspection device 90, according to an exemplary embodiment. The method includes providing a camera having an optical input and a fiber inspection device removably attached to the camera (block 108). Next, an end portion of the first optical fiber is disposed proximate to an optical fiber guide of the fiber inspection device (block 110). The method also includes receiving light returned from the optical fiber guide at the optical input of the camera via a first inspection optical interface of the beam splitter, wherein the optical splitter is further configured to direct returned light returned in a first optical path from the optical fiber guide via the second inspection optical interface to an inspection optical output in a second optical path, to be imaged by the camera (block 112).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1. A fiber inspection device configured to be removably attached to a portable camera for inspecting an optical fiber, comprising:
an adapter ferrule comprising a microhole disposed between a first end and a second end of the adapter ferrule, the adapter ferrule configured to receive an end portion of a first optical fiber via the first end of the adapter ferrule such that an endface of the first optical fiber extends to the second end of the adapter ferrule; and
a beam splitter comprising:
an inspection optical interface configured to receive and direct light returned from the endface of the first optical fiber in a first optical path; and
at least one optical splitter disposed in the first optical path configured to direct returned light returned from the microhole via the first inspection optical interface to an inspection optical output in a second optical path perpendicular to the first optical path, to be imaged by the portable camera.

2. The fiber inspection device of claim 1, wherein the beam splitter further comprises a source optical input configured to receive source light from a light source in a third optical path, and to direct the source light to the at least one optical splitter along the third optical path, the at least one optical splitter further configured to direct the source light to the microhole via the first inspection optical interface.

3. The fiber inspection device of claim 2, further comprising a lens disposed in a fourth optical path, the lens configured to direct the light from the light source to the source optical input.

4. The fiber inspection device of claim 3, further comprising a beam bender configured to direct the light received from the at least one lens in the fourth optical path to the source optical input in the third optical path.

5. The fiber inspection device of claim 3, further comprising at least one band pass filter disposed in at least one of the third optical path and the fourth optical path.

6. The fiber inspection device of claim 3, wherein the fiber inspection device is configured to be removably attached to at least one outer surface of the portable camera such that the fourth optical path is perpendicular or substantially perpendicular to at least one of the at least one outer surface.

7. The fiber inspection device of claim 1, further comprising at least one first micro-objective lens disposed between the inspection optical interface and the microhole of the adapter ferrule.

8. The fiber inspection device of claim 7, wherein the at least one first micro-objective lens is a GRIN lens.

9. The fiber inspection device of claim 1, wherein the inspection optical interface is a first inspection optical interface, the fiber inspection device further comprising:
an optical fiber guide configured to guide and maintain an end portion of a second optical fiber; and
a second inspection optical interface disposed in the beam splitter configured to receive and direct light returned from the end portion of the second optical fiber in a third optical path;
wherein the at least one optical splitter is further disposed in the third optical path and configured to direct returned light returned from the optical fiber guide via the second inspection optical interface to the inspection optical output, to be imaged by the portable camera.

10. The fiber inspection device of claim 9, further comprising at least one first micro-objective lens disposed between the second inspection optical interface and the optical fiber guide.

11. The fiber inspection device of claim 10, wherein each of the at least one first micro-objective lens and at least one second micro-objective lens is a GRIN lens.

12. The fiber inspection device of claim 1, further comprising an aperture stop configured to align the inspection optical output with an optical input of the portable camera.

13. The fiber inspection device of claim 12, wherein the aperture stop is further configured to block light sources other than the inspection optical output from reaching the optical input of the portable camera.

14. The fiber inspection device of claim 1, wherein the portable camera is integrated into a mobile computing device, the fiber inspection device being further configured to be removably attached to the mobile computing device.

15. The fiber inspection device of claim 1, wherein the optical fiber guide comprises a microhole disposed between the first end and a second end of the optical fiber guide, the microhole configured to receive the end portion of a first optical fiber.

16. The fiber inspection device of claim 1, wherein the optical fiber guide comprises an adapter ferrule configured to receive the end portion of optical fiber.

17. A method of inspecting optical fiber comprising:
providing a portable camera having an optical input and a fiber inspection device removably attached to the portable camera;
inserting an end portion of the first optical fiber into a microhole of an adapter ferrule of the fiber inspection device having a first end and a second end such that an endface of the first optical fiber extends to the second end of the adapter ferrule; and
receiving light returned from the microhole in an input optical path at the optical input of the camera via a first inspection optical interface of a beam splitter in the input optical path configured to direct returned light returned from the microhole via the first inspection optical interface to an inspection optical output in an output optical path perpendicular or substantially perpendicular to the input optical path, to be imaged by the portable camera.

18. The method of claim 17, further comprising:
displaying a representation of the light returned from the microhole on a display of the portable camera.

19. The method of claim 17, further comprising:
storing information representative of the light returned from the microhole via the portable camera.

20. The method of claim 17, wherein the portable camera is integrated into a mobile computing device, the method further comprising:
using an application on the mobile computing device to analyze the images taken by the camera.

21. An optical fiber inspection system, comprising:
a portable camera having an optical input and a camera body; and
a fiber inspection device removably attached to the portable camera for inspecting an optical fiber, comprising:
an adapter ferrule comprising a microhole disposed between a first end and a second end of the adapter ferrule, the adapter ferrule configured to receive an end portion of a first optical fiber via the first end of the adapter ferrule such that an endface of the first optical fiber extends to the second end of the adapter ferrule; and
a beam splitter, comprising:
an inspection optical interface configured to receive and direct light returned from the endface of the first optical fiber in a first optical path; and
at least one optical splitter disposed in the first optical path configured to direct returned light returned from the microhole via a first inspection optical interface to the optical input of the camera via an inspection optical output in a second optical path perpendicular to the first optical path, to be imaged by the portable camera.

22. The system of claim 21, wherein the beam splitter further comprises a source optical input configured to receive source light from a light source in a third optical path, and to direct the source light to the at least one optical splitter along the third optical path to the at least one optical splitter, the at least one optical splitter further configured to direct the source light to the microhole via the first inspection optical interface.

23. The system of claim 21, wherein the fiber inspection device further comprises an aperture stop configured to align the inspection optical output with the optical input of the camera.

24. The system of claim 21, wherein the portable camera is configured to:
image the endface of the optical fiber as a captured image; and
analyze the captured image.
